(19) United States
(12) Patent Application Publication
(10) Pub. No.: US 2009/0089654 A1
(43) Pub. Date: Apr. 2, 2009

(54) METHOD AND SYSTEM FOR PERSONALIZING COMMUNICATION ITEMS

(75) Inventors: Frank Wittig, Spiesen Elversberg (DE); Dirk Wagner, Schiffweiler (DE); Tamara Juschkova, Wiesloch (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 11/862,782

(22) Filed: Sep. 27, 2007

(51) Int. Cl. G06F 15/00

(52) U.S. Cl. 715/223

(57) ABSTRACT

Methods and systems are described for personalizing communication items. An example system may include a personalized communication manager including a template information manager configured to obtain template information associated with a personalized communication item via one or more application programming interfaces, and a hierarchical template manager configured to generate a hierarchical template including a description of an execution service associated with the personalized communication item based on the template information. The execution service may be configured to provide the personalized communication item to a target recipient based on the hierarchical template.

### TECHNICAL FIELD

This description relates to techniques for personalizing communication items.

### BACKGROUND

Relationships among entities such as businesses and customers may be developed or improved by personalizing communications among target recipients of messages or other communication items shared among the entities. For example, many businesses recognize that personalized customer service may encourage customers to continue and expand a business relationship over time, thus driving new growth and helping the business to achieve or maintain competitive agility.

As an example, customer relationship management (CRM) may involve acquiring and retaining customers or other types of business partners, improving loyalty and gaining insight among such business partners, and implementing strategies focused on such customers or business partners.

Developing personalized communications may involve obtaining information regarding target recipients of messages. For example, a business may obtain personal information regarding customers or potential customers such as their name, contact information, purchase history and/or personal preferences. The business may then develop marketing campaigns or newsletters that may be personalized for each individual target recipient based on the obtained information. However, it may be impractical for businesses with a large number of customers, potential customers or other desired target recipients of communication items to manually generate each such personalized communication item.

Thus, it may be desirable to provide techniques for personalizing communication items.

### SUMMARY

According to one general aspect, a system includes a personalized communication manager including a template information manager configured to obtain template information associated with a personalized communication item via one or more application programming interfaces, and a hierarchical template manager configured to generate a hierarchical template including a description of an execution service associated with the personalized communication item based on the template information. The execution service may be configured to provide the personalized communication item to a target recipient based on the hierarchical template.

According to yet another aspect, a system includes a database layer configured to store template information associated with a personalized communication item and a template including a description of an execution service associated with the personalized communication item based on the template information, wherein the execution service is configured to provide the personalized communication item to a target recipient based on the hierarchical template. The system further includes an interaction controller including one or more application programming interfaces and a user interface configured to receive user input associated with the template and template information. The system further includes a business logic controller configured to obtain the template information via the interaction controller, and a persistency controller configured to store and retrieve information associated with the database layer.

According to yet another aspect, a method includes obtaining template information associated with a personalized communication item via one or more application programming interfaces. The method further includes generating a hierarchical template including a description of an execution service associated with the personalized communication item based on the template information, wherein the execution service is configured to provide the personalized communication item to a target recipient based on the hierarchical template.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for personalizing communication items.

FIG. 2 is a diagram of an example structure of a hierarchical template for personalizing communication items according to an example embodiment.

FIG. 3 is a block diagram of a system for personalizing communication items according to an example embodiment.

FIG. 4 is a flowchart illustrating an operation of the system of FIG. 1 according to an example embodiment.

FIGS. 5a-5b are screen shots illustrating a user interface based on a hierarchical template structure according to an example embodiment.

FIG. 6 is a screen shot illustrating a search view according to an example embodiment.

FIG. 7 is a screen shot illustrating an editing view according to an example embodiment.

FIG. 8 is a screen shot illustrating an attribute editing view according to an example embodiment.

FIG. 9 is a screen shot illustrating a Uniform Resource Locator (URL) editing view according to an example embodiment.

FIG. 10 is a screen shot illustrating a template or mailform copying view according to an example embodiment.

FIG. 11 is a screen shot illustrating a channel test view according to an example embodiment.

FIG. 12 is a screen shot illustrating a structure editing view according to an example embodiment.

FIG. 13 is a screen shot illustrating an attachment assignment view according to an example embodiment.

FIG. 14 is a screen shot illustrating a translation view according to an example embodiment.

FIG. 15 is a screen shot illustrating a test send view according to an example embodiment.

FIG. 16 illustrates a database design according to an example embodiment.

FIG. 17 illustrates classes associated with the system of FIG. 3 according to an example embodiment.

FIG. 18 illustrates an architectural view of a layer associated with the system of FIG. 3 according to an example embodiment.

FIG. 19 illustrates an architectural view of a layer associated with the system of FIG. 3 according to an example embodiment.

FIG. 20 is a timing diagram illustrating editing of a test message according to an example embodiment.

### DETAILED DESCRIPTION

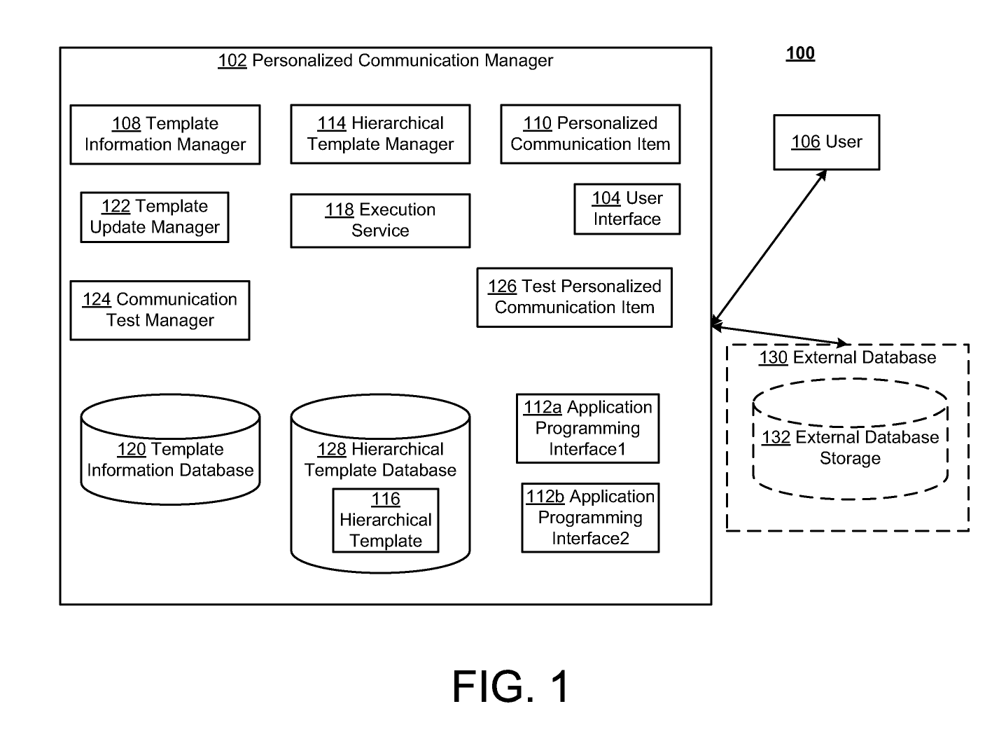

FIG. 1 is a block diagram of a system 100 for personalizing communication items according to an example embodiment. In the example of FIG. 1, a personalized communication manager 102 includes various processing engines that may be configured to manage personalized communications. According to an example embodiment, the personalized communication manager 102 may include a user interface 104 configured to manage communication with a user 106.

According to an example embodiment, the personalized communication manager 102 may include a template information manager 108 configured to obtain template information associated with a personalized communication item 110 via one or more application programming interfaces 112a, 112b. For example, the template information may include information related to desired elements of the personalized communication item 110 such as name fields and subject lines to be included in a generated message to be provided to target recipients. For example, the template information may included personalization features such as one or more backgrounds for messages that may depend on each intended target recipient, or a language dependent on a region associated with the target recipient, or any type of personalized preferences associated with the individual target recipient.

The personalized communication manager 102 may further include a hierarchical template manager 114 configured to generate a hierarchical template 116 including a description of an execution service 118 associated with the personalized communication item 110 based on the template information, wherein the execution service 118 is configured to provide the personalized communication item 110 to a target recipient based on the hierarchical template 116. According to an example embodiment, the template information may be stored in a template information database 120.

According to an example embodiment, the personalized communication manager 102 may include a template update manager 122 configured to update the hierarchical template 116 via the user interface 104.

According to an example embodiment, the hierarchical template manager 114 is configured to generate the hierarchical template 116 according to a hierarchical ordering based on one or more of: one or more attribute structures associated with the personalized communication item 110, one or more methods associated with the personalized communication item 110, or one or more relations associated with the personalized communication item 110.

According to an example embodiment, the template information manager 108 may be configured to update the template information via the user interface 104.

According to an example embodiment, the personalized communication manager 102 further comprises: a communication test manager 124 configured to generate test personalized communication items 126 based on the hierarchical template 116 for review by a user (e.g., the user 106) of the system 100.

According to an example embodiment, the personalized communication manager 102 further comprises: a template information database 120 configured to store the template information; a hierarchical template database 128 configured to store the hierarchical template; and a template update manager 122 configured to update the hierarchical template based on user input, and store the updated hierarchical template in the hierarchical template database 128, wherein the template information manager 108 is configured to update the template information based on user input, and store the updated template information in the template information database 120.

According to an example embodiment, the hierarchical template 116 may include one or more of: one or more variables indicating one or more attributes associated with the target recipient; one or more condition indicators indicating conditions for including predetermined content in the personalized communication item 110; one or more indicators of data values, attachments, hyperlink tracking, response tracking, personalized subject lines, or subscriptions to newsletters for inclusion in the personalized communication item 110.

According to an example embodiment, the personalized communication item 110 may include one or more of an email message, a facsimile message, a letter, a personalized web page, or an electronic text message. One skilled in the art of data processing will appreciate that many other forms of personalized communication may also be used without departing from the spirit of the present discussion.

According to an example embodiment, an external database 130 may include an external database storage area 132 for storing database information external to the personalized communication manager 102. For example, the user 106 may wish to generate personalized communication items 126 based at least in part on information stored in the external database 130

According to an example embodiment, a user such as a business may generate a personalized contact with its customers as part of marketing campaigns. For example, the personalized contact may include individual product offerings, or may be realized via an appropriate choice of a correspondence language, salutation, first name, name, address, or other personalized features. Such a personalized approach may contribute significantly, for example, to an increase in customer loyalty from a business perspective.

According to an example embodiment, personalization features of a system may include a design tool that may enable the construction of personalizable templates for marketing documents, and the execution of marketing campaigns that may include the personalization. For example, during execution, placeholders included in a template may be exchanged for actual values related to a target recipient under consideration (e.g., Hello <First Name>! may be exchanged for “Hello Frank!”).

According to an example embodiment, personalizable templates of marketing documents may be designed for many different types of contact channels, for example, an email message, a facsimile message, a letter, a personalized web page, a Short Message Service (SMS) message, a message included in a file export, or an electronic text message.

According to an example embodiment, the system 100 may include a flexible framework that may be based on industry standards and may be easily extended by new personalization features.

According to an example embodiment, personalization features may include one or more of:

1. Personalization attributes: Placeholders for personalized target recipient attributes may be inserted into templates that are exchanged for their actual values during the execution phase.

2. Personalized structure of documents: The structure of the documents received by the target recipient may be personalized via conditions such as “if the target recipient has an address in country XX then remove this section.” Theses conditions may be specified during the design phase of the templates.

3. Hyperlink tracking: Hyperlinks pointing to web sites may be inserted into templates. According to an example embodiment, after a target recipient receives a message, tracking may be provided regarding whether the recipient clicks on a hyperlink associated with a web shop. Thus, for example, various analyses may be provided regarding recipient reactions to a campaign.

4. Response tracking: The templates may include automatic response tracking features. Thus, for example, various analyses may be provided regarding impact/success of campaigns or strategies.

5. Personalized attachments: Different target recipients or groups of target recipients may receive different attachments.

6. Personalized subjects: Templates may include personalized attributes associated with text portions of a communication item, as well as with a subject, for example, a subject line associated with the communication item (e.g., for personalization during the execution phase).

7. Subscription to newsletters: Subscription links to (personalized) newsletters (e.g., personalized newsletter) may be inserted into the templates.
8. Translation of text portions of communication items into multiple correspondence languages.

According to an example embodiment, the system 100 may include a flexible framework that may include personalization features such as personalization attributes (e.g., business partner attributes), translation of templates to correspondence languages and personalized content blocks (e.g., text blocks, attachments).

According to an example embodiment, a designer of a template may test the template, for example by sending a test email message to himself/herself. For example, the designer may test the template immediately after creation or edit via a user interface such as the user interface 104.

According to an example embodiment, interfaces such as the APIs 112a, 112b may provide extensions by arbitrary further personalization features. According to an example embodiment, industry standards such as Hypertext Markup Language (HTML) and eXtensible Markup Language (XML) may be used to ensure realizations of such extensions.

According to an example embodiment, templates such as the hierarchical template 116 may be used in association with marketing documents.

According to an example embodiment, the system 100 may provide personalized mails associated with marketing by a user.

According to an example embodiment, the system 100 may provide an email response management system for mail templates that may be used for automatically generated answers.

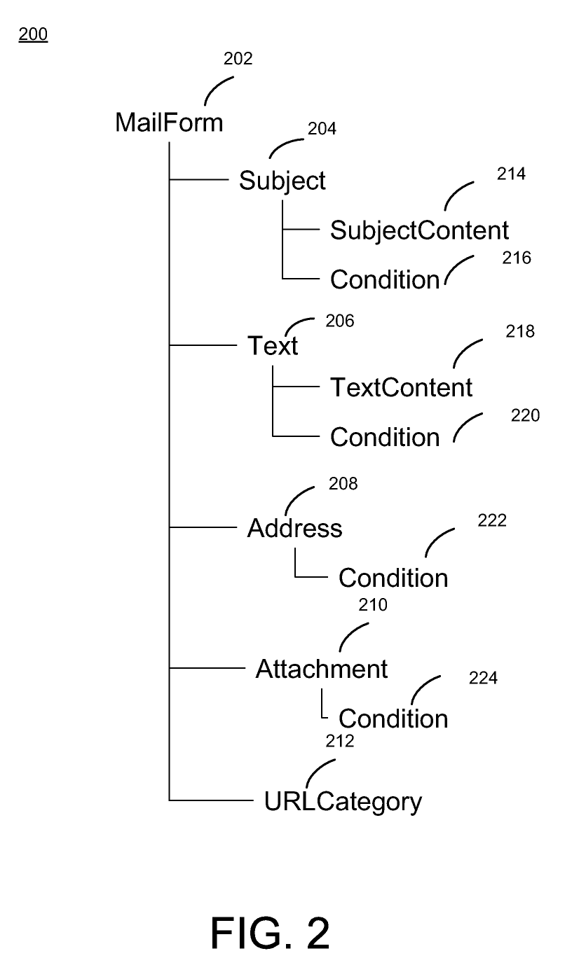

FIG. 2 illustrates a hierarchical template structure 200 according to an example embodiment. For example, the hierarchical template 116 may include the example hierarchical template structure 200. In the example of FIG. 2, a Mailform 202 template structure includes example elements Subject 204, Text 206, Address 208, Attachment 210, and URLCategory 212. Each of the elements on a first level may include hierarchical sub-levels. For example, the element Subject 204 may include sub-levels SubjectContent 214 and Condition 216. Thus, for example, a particular content associated with a particular subject may be included (or not included) in a personalized communication item 110 if conditions 216 are met.

According to an example embodiment, each element associated with a sub-level in the hierarchical structure 200 may be accessed via its parent element in the hierarchical structure 200. For example, the sub-level element Condition 216 may be accessed via Mailform 202 and Subject 204.

As other examples, the element Text 206 may include sub-levels TextContent 218 and Condition 220, the element Address 208 may include sub-level Condition 222, and the element Attachment 210 may include sub-level Condition 224. Thus, for example, a particular attachment may be included with a particular personalized communication item 110 if conditions 224 are met. According to an example embodiment, the elements of the hierarchical template structure 200 may be evaluated by the execution service 118 at run time.

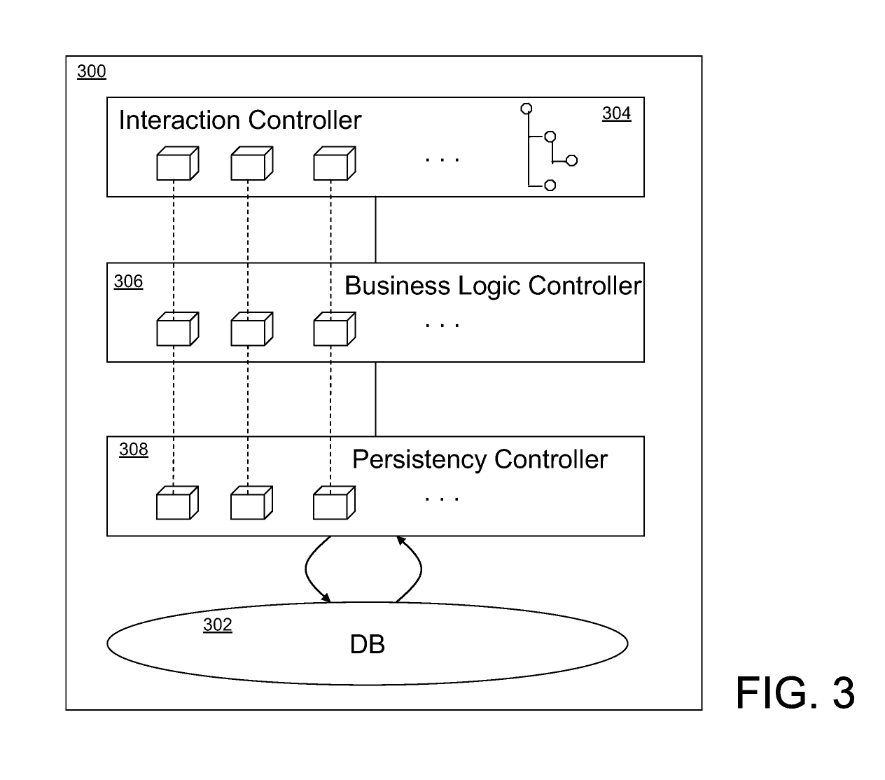

FIG. 3 is a block diagram of a system 300 for personalizing communication items according to an example embodiment. In the example of FIG. 3, a database layer 302 may be configured to store template information associated with a personalized communication item and a template including a description of an execution service associated with the personalized communication item based on the template information, wherein the execution service is configured to provide the personalized communication item to a target recipient based on the template; an interaction controller 304 including one or more application programming interfaces and a user interface configured to receive user input associated with the template and template information; a business logic controller 306 configured to obtain the template information via the interaction controller; and a persistency controller 308 configured to store and retrieve information associated with the database layer 302.

According to an example embodiment, the interaction controller 304 may be configured to receive requests for updating the template and template information. For example, the interaction controller 304 may receive requests from a user such as the user 106 discussed previously.

According to an example embodiment, the interaction controller 304 may be configured to receive requests for one or more of creating, reading, updating, or deleting information elements associated with the template.

According to an example embodiment, the persistency controller 308 may be configured to store and retrieve information associated with the database layer 302 in binary format. Thus, for example, users on different platforms may retrieve the information and view a display of the information via a format associated with the platform in use by the user.

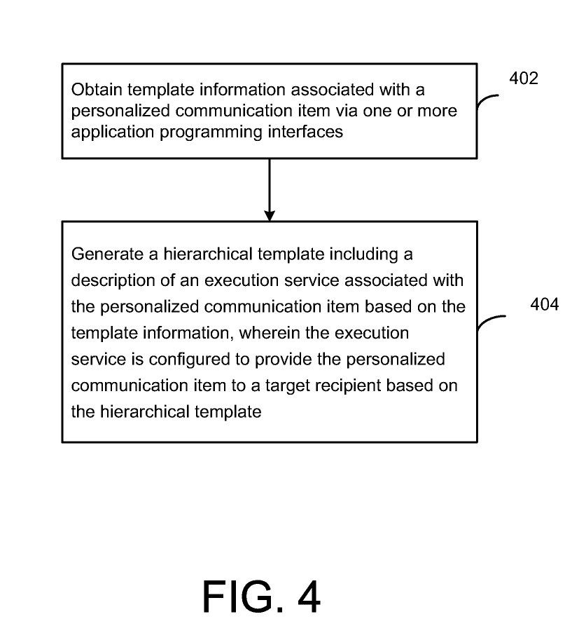

FIG. 4 is a flowchart illustrating an operation of the system of FIG. 1. According to an example embodiment, a method may include obtaining template information associated with a personalized communication item via one or more application programming interfaces (402). For example, the template information manager 108 may obtain template information associated with a personalized communication item 110 via one or more application programming interfaces 112a, 112b as discussed previously.

According to an example embodiment, the method may further include generating a hierarchical template including a description of an execution service associated with the personalized communication item based on the template information, wherein the execution service is configured to provide the personalized communication item to a target recipient based on the hierarchical template (404). For example, the hierarchical template manager 114 may generate the hierarchical template 116 including a description of an execution service 118 associated with the personalized communication item 110 based on the template information, wherein the execution service 118 is configured to provide the personalized communication item 110 to the target recipient based on the hierarchical template 116, as discussed previously.

According to an example embodiment, the generating the hierarchical template includes generating the hierarchical template according to a hierarchical ordering based on one or more of: one or more attribute structures associated with the personalized communication item, one or more methods associated with the personalized communication item, or one or more relations associated with the personalized communication item.

According to an example embodiment, the method may further include updating the hierarchical template via a user interface. For example, the template update manager 122 may update the hierarchical template 116 via the user interface 104 as discussed previously.

According to an example embodiment, the method may further include updating the template information via a user interface. For example, the template information manager 108 may update the template information via the user interface 104 as discussed previously.

According to an example embodiment, the method may further include storing the template information in a template information database; storing the hierarchical template in a hierarchical template database; updating the template information based on user input, the updated template information stored in the template information database; and updating the hierarchical template based on user input, the updated hierarchical template stored in the hierarchical template database. For example, the template information database 120 may store the template information; the hierarchical template database 128 may store the hierarchical template; and the template update manager 122 may update the hierarchical template based on user input, and store the updated hierarchical template in the hierarchical template database 128, wherein the template information manager 108 may update the template information based on user input, and store the updated template information in the template information database 120 as discussed previously.

According to an example embodiment, the hierarchical template may include one or more of: one or more variables indicating one or more attributes associated with the target recipient; one or more condition indicators indicating conditions for including predetermined content in the personalized communication item; one or more indicators of data values, attachments, hyperlink tracking, response tracking, personalized subject lines, or subscriptions to newsletters for inclusion in the personalized communication item.

According to an example embodiment, the personalized communication item may include one or more of an email message, a facsimile message, a letter, a personalized web page, a Short Message Service (SMS) message, a message included in a file export, or an electronic text message.

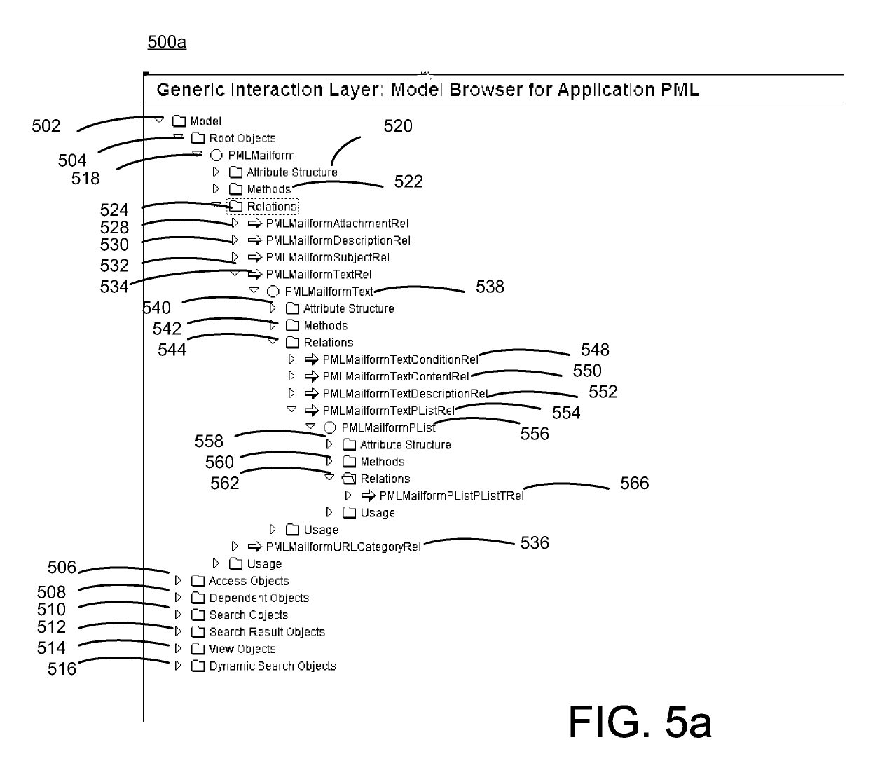

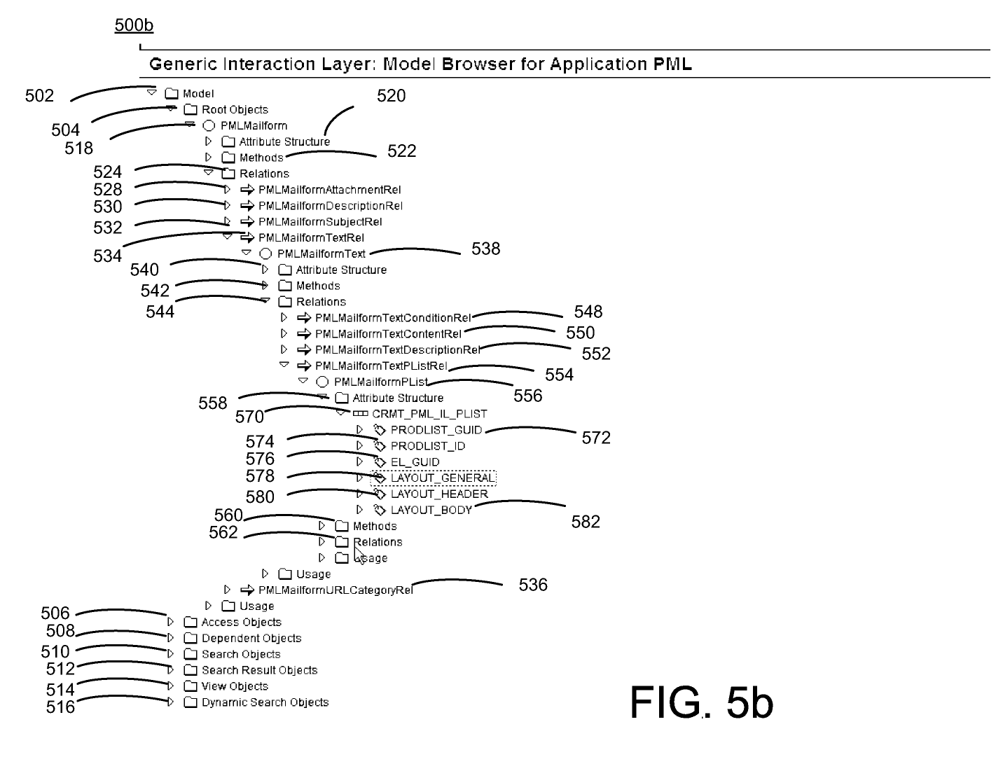

FIGS. 5a-5b are screen shots 500a, 500b illustrating a user interface based on a hierarchical template structure according to an example embodiment. In the example of FIG. 5a, a Model 502 may include a hierarchical template structure that may be accessed by a user such as the user 106 via the user interface 104 discussed previously. The Model 502 may include example hierarchical sub-elements Root Objects 504, Access Objects 506, Dependent Objects 508, Search Objects 510, Search Result Objects 512, View Objects 514, and Dynamic Search Objects 516, which may be displayed, for example, in a browser by a user selecting the Model 502, for example, by clicking the Model 502 with a pointing device such as a mouse. Each of these hierarchical sub-elements may include hierarchical sub-elements, which may also be displayed by selecting a desired sub-element for viewing. For example, Root Objects 504 may include a hierarchical sub-element PMLMailform 518, which may include a structure similar to the structure of the Mailform 202 discussed previously with regard to FIG. 2.

As shown in FIG. 5a, PMLMailform 518 may include example hierarchical sub-elements Attribute Structure 520, Methods 522, and Relations 524. The hierarchical sub-element Relations 524 may include hierarchical sub-elements PMLMailformAttachmentRel 528, PMLMailformDescriptionRel 530, PMLMailformSubjectRel 532, PMLMailformTextRel 534, and PMLMailformURLCategoryRel 536.

The hierarchical sub-element PMLMailformTextRel 534 may include a hierarchical sub-element PMLMailformText 538, which may include hierarchical sub-elements Attribute Structure 540, Methods 542, and Relations 544. The hierarchical sub-element Relations 544 may include hierarchical sub-elements PMLMailformTextConditionRel 548, PMLMailformTextContentRel 550, PMLTextDescriptionRel 552, and PMLMailformTextPListRel 554.

The hierarchical sub-element PMLMailformTextPListRel 554 may include a hierarchical sub-element PMLMailformPList 556, which may include hierarchical sub-elements Attribute Structure 558, Methods 560, and Relations 562. The hierarchical sub-element Relations 562 may include a hierarchical sub-element PMLMailformPListPListTRel 566, which may be selected by a user such as the user 106 for viewing or editing. As shown in the example of FIG. 5a, the user may access the hierarchical sub-element PMLMailformPListPListTRel 566 via the hierarchical template elements Model 502, Root Objects 504, PMLMailform 518, Relations 524, PMLMailformTextRel 534, PMLMailformText 538, Relations 544, PMLMailformTextPListRel 554, PMLMailformPList 556, and Relations 562, as indicated by the hierarchical ordering of the respective elements and sub-elements.

Similarly to FIG. 5a, FIG. 5b illustrates a screen shot 500b in which a user has selected the hierarchical sub-element Attribute Structure 558, which includes an example hierarchical sub-element CRMT_PML_IL_PLIST 570, which may include hierarchical sub-elements PRODLIST_GUID 572, PRODLIST_ID 574, EL_GUID 576, LAYOUT_GENERAL 578, LAYOUT_HEADER 580, and LAYOUT_BODY 582. As shown in FIG. 5b, a user has selected the hierarchical sub-element LAYOUT_GENERAL 578 for editing or viewing. By editing the hierarchical sub-elements a user may modify attribute values or add structure to elements, for example, of the personalized communication item 110 via the hierarchical template 116.

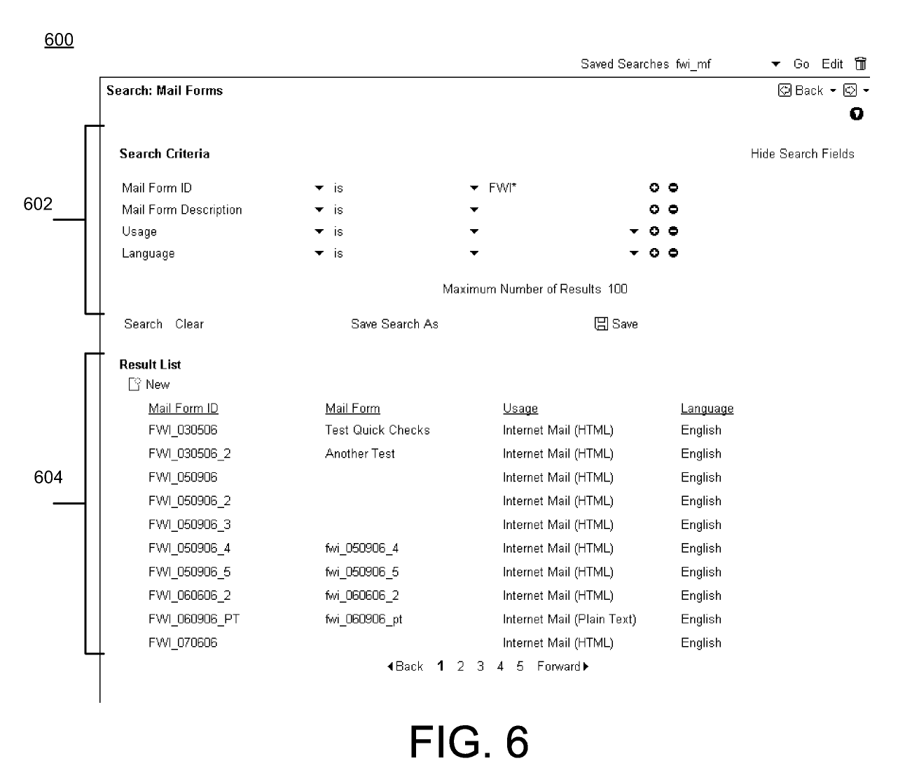

FIG. 6 is a screen shot illustrating a search view 600 according to an example embodiment. According to an example embodiment, a search may be based on search criteria 602 which may be input by a user such as the user 106 via the user interface 104. For example, search criteria 602 may include conditional search criteria based on one or more of a template or mail form ID, a template or mail form description, a usage, or a language.

According to an example embodiment, new templates or mail forms may be generated directly from a search result list 604 indicating results of a search, and copies may be generated based on a selection of a listed template or mail form by a user.

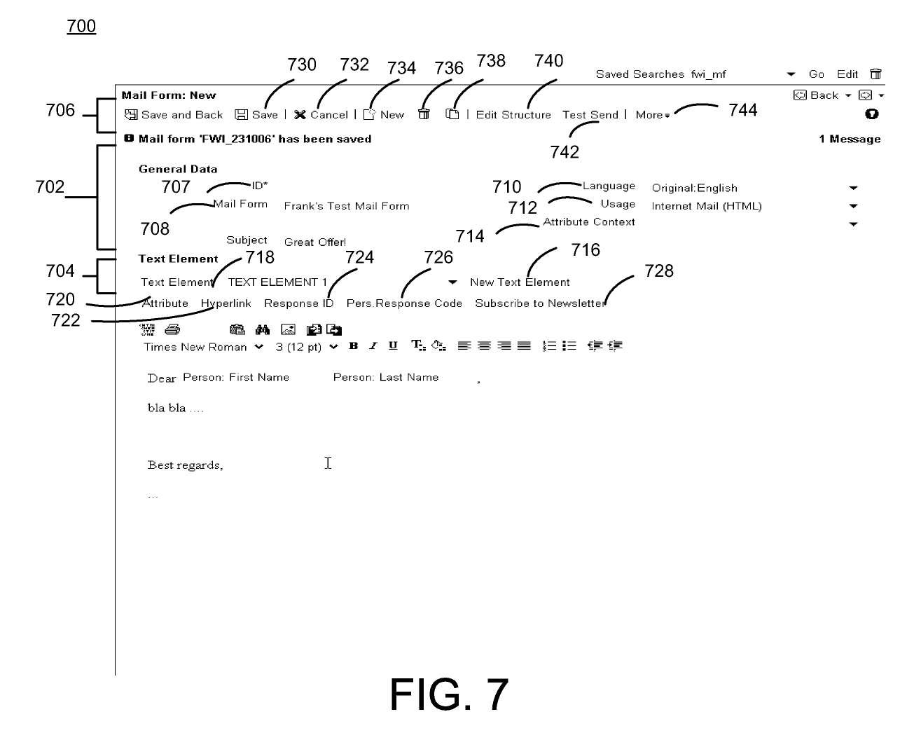

FIG. 7 is a screen shot illustrating an editing view 700 according to an example embodiment. According to an example embodiment, a main edit screen may be used for maintenance of general data 702, editing of text elements 704, or navigation 706 to additional editing functions associated with templates or mail forms.

As shown in the example of FIG. 7, the maintenance of general data 702 may include editing a template or mail form ID 707, editing a Template or mail form description 708, or editing a language 710. For example, if a translation of a template or mail form element exists, the language 710 may be selected. The corresponding data may be displayed in the language 710 fields, in particular the corresponding translation of the text element in focus may be displayed. By default, the original language of the template or mail form may be selected (e.g., the language in which the template or mail form has been created).

According to an example embodiment, a translation feature may be used to generate different language versions of a template or mail form. For example, a user may wish to run a campaign that is targeted to recipients of different nationalities.

According to an example embodiment, the user may generate a language version for each supported language. Supported languages may then be listed, for example, in the language element 710. According to an example embodiment, the user may generate language versions of individual text elements in a template or mail form, a subject line in a template or mail form, or a description for the text element or template or mail form. When a language version of a text element is generated, a language version of the template or mail form may be automatically generated. The user may choose to insert the text from the original language, and may then translate the text element sentence by sentence, overwriting the text from the original language.

According to an example embodiment, when a language version of a description is generated, then any such language versions may be used for a search of the template or mail form based on its description.

According to an example embodiment, a language version of a text element or mail form may include the same ID as the version from the original language (e.g., the language in which the mail form was created).

The maintenance of general data 702 may further include editing a usage 712. The usage field 712 may indicate an intended usage of the template or mail form (e.g., Hypertext Markup Language (HTML) email, plain text email, Short Message Service (SMS), facsimile, personalized web page). The usage field 712 may serve as information and may be used as categorization criteria by the user. The maintenance of general data 702 may further include editing an attribute context 714. For example, an attribute context may determine which attributes may be available for selection in a template or mail form. For example, a dropdown listbox 718 may indicate a list of attributes that is available as part of the personalization.

According to an example embodiment, the edit text elements 704 portion of the editing view 700 may include a “New Text Element” button 716 configured to request a popup for adding new text elements. Further, an example dropdown listbox from a “Text Element” field 718 may display text elements that may be selected for editing.

According to an example embodiment, selectable buttons, shown below the text element portion 704 in the example of FIG. 7, may reflect the marketing-specific elements for generating templates or mail forms, such as including personalization attributes 720, tracking-enabled hyperlinks 722, Response ID 724, a personal response code 726, and a subscribe to newsletter 728.

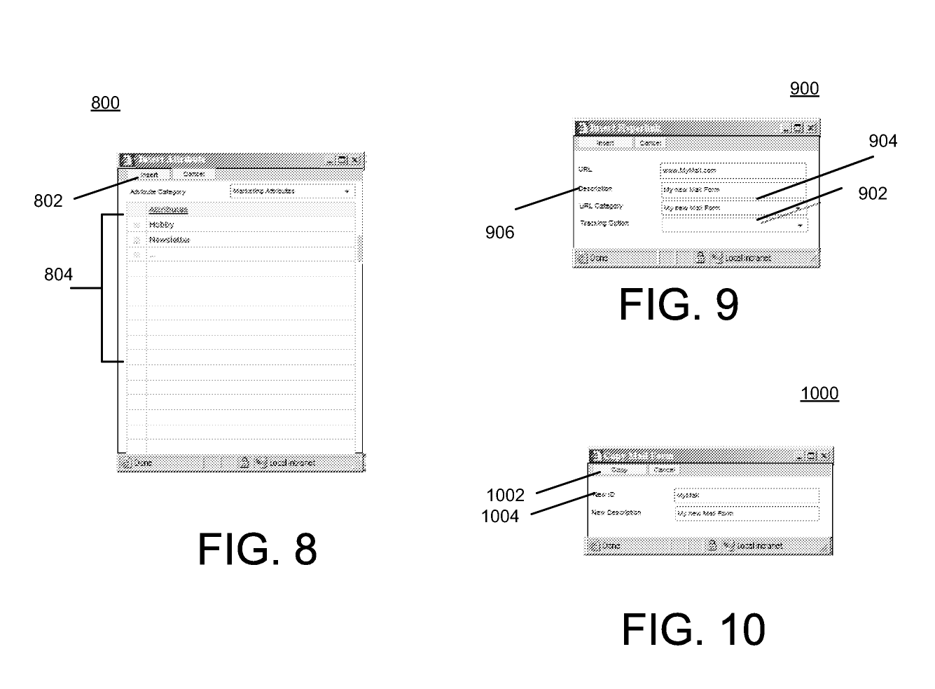

According to an example embodiment, by selecting Attribute 720 a user may specify the insertion of personalized content in templates or mail forms. For example, in templates or mail forms of usage Internet Mail, Fax, or SMS, the user may specify the insertion of personalized details. According to an example embodiment, attributes may be inserted in text elements, hyperlinks, and the subject line of a template or mail form. The current values for these attributes may then be inserted when the personalized communication item is sent. Thus, for example, a variable or personalized text, such as marketing attributes or master data may be inserted. According to an example embodiment, for mail forms of usage File Export, lists of business partners with corresponding attribute values may be generated. Thus, when a file may be generated for specified target groups, the current values for selected attributes may be inserted. A list of target recipients that are in the target group, as well as the values of the attributes specified in the template or mail form, may thus be obtained. FIG. 8 is a screen shot illustrating an attribute editing view 800 according to an example embodiment. In the example as shown in FIG. 8, a user may select “Insert” 802 to insert an attribute list 804 into a template or mailform. According to an example embodiment, the attribute editing view 800 may be generated as a popup view for the user.

According to an example embodiment, an attribute category may include a collection of attributes with a common theme, which may aid in searching for a particular attribute. According to an example embodiment, attribute categories may include business partner, marketing attributes, campaigns, system attributes, or additional fields. According to an example embodiment, additional attributes may be customized.

According to an example embodiment, when a user creates a file for specified target groups, the current values for the attributes that have been selected may be inserted. Thus, a list of the business partners that are in the target group may be obtained, as well as the values of the attributes specified in the template or mail form.

According to an example embodiment, a user may also use attributes to generate conditions in mail forms.

According to an example embodiment, a user may monitor reactions of the target recipients to personalized communication items, for example, via response tracking. For example, a user may use response tracking in order to better monitor the effectiveness of personalized message campaigns. As shown in the example of FIG. 7, a user may use one or more of Response IDs 724, Personalized Response Codes 726, or Response Tracking with Hyperlinks 722. For example, a Response ID 724 may include outbound tracking information, including the target recipient, template or mail form, and campaign. Response IDs 724 may be inserted in text elements, and may not be visible in an example personalized message, and thus may be more useful in sending Internet mail. According to an example embodiment, if a recipient responds to personalized mail, the response ID of this inbound mail may be read by the system 100. FIG. 9 is a screen shot illustrating a Uniform Resource Locator (URL) editing view according to an example embodiment. As shown in the example of FIG. 9, a tracking option 902 may indicate a user preference for tracking responses of recipients of communication items.

According to an example embodiment, a personalized response code 726 may include outbound tracking information, including the recipient, template or mail form, and campaign. For example, a personalized response code 726 may include an ID with 10 characters.

According to an example embodiment, a personalized response code 726 may be visible in personalized messages, and may thus be used when a user is sending fax or SMS, or when using file export. According to an example embodiment, a recipient may then quote the personalized response code 726 when responding to the personalized message. According to an example embodiment, a personalized response code 726 may be included in text elements and in the subject of the template or mail form, and the ID may then be generated when the communication item is sent.

According to an example embodiment, a user may monitor responses to hyperlinks sent in the communication via tracking functions associated with the hyperlink 722. According to an example embodiment, the user may select tracking through an intermediate site or tracking through a target site. When intermediate site tracking is selected, a globally unique identifier (GUID) may be generated that identifies the recipient and campaign. Target site tracking may be selected for internal Web pages (e.g., a Web shop), where GUID information may be recorded.

According to an example embodiment, a multiple-link tracking feature may be used to add different links to Web sites in an example template or mail form. On these Websites, target recipients may be offered additional information, such as information on product offerings, downloads, newsletter registration, or links to Web shops. According to an example embodiment, the user may determine whether the recipient of a communication item actually clicks on the links provided, and whether the recipient branches into different pages of the Web site.

According to an example embodiment, in order to track links, the user may generate a template or mail form with URLs that include the tracking option. Additionally, the user may generate mappings to enable access to redirection services, for example, on a Web Application Server (WAS).

According to an example embodiment, during campaign execution, a “##” sign that may be included at the end of a URL may be replaced by a tracking ID, and the URL itself may be replaced, for example, by a Web Application Server URL (WAS URL). For example, a URL “www.sap.com” (e.g., inserted via template or mail form maintenance) may be replaced at runtime with “pwdf0../SAP/.../CRM_TRACKING?MIG=....&TARGET=www.sap.com” along with other parameters such as parameters MIG and URLGUID. This URL may then be replaced by a URL with a specific port that is accessible, for example, to target recipients behind a firewall, which include a URL that may be visible to the recipient of the email.

The example mapping may be processed when the user clicks on the link. An example tracking service may be executed and the URL named in the parameter TARGET (e.g., “www.sap.com”) may be called. With this tracking service, example counters for the single URL and for the total number of clicks within the message may be increased.

According to an example embodiment, a user may use these features to generate a hierarchy of link categories. These example categories may structure various links used in campaigns. For example, when a large number of links are provided in a template or mail form, the example categories may provide an overview of the most important links (e.g., based on importance to the user) or the most highly prioritized or lowest prioritized links in a campaign and within a template or mail form. When large numbers of links are provided, an overview of the most popular or most important links (or least important links) within a campaign or a mail form may help in streamlining campaigns.

For example, link categories may include links for different products and further information about the products, links for registration to newsletters, links to download brochures, programs, and updates.

According to an example embodiment, links used within a mail form may be assigned to a special category. Campaign managers may then use these link categories to obtain an overview about the types of categories that are successful within a particular campaign or across all campaigns.

According to an example embodiment, a user may generate reports on activities related to target recipients, campaigns, and categories of links. Example data included in reports may include who clicked on a link (e.g., recipient), when the link was clicked (e.g., time: date and time), how often a link is clicked (e.g., counter), which link is clicked (e.g., a special link or link category), or a total number of clicks for all URLs within the communication item.

According to an example embodiment, the navigation portion 706 may include additional features such as Save 730, Cancel 732, New 734, Delete 736, or Copy 738. FIG. 10 is a screen shot illustrating a template or mailform copying view 1000 according to an example embodiment. As shown in the example of FIG. 10, a user may select “Copy” 1002 to generate a copy of a selected template or mailform having a new ID value 1004 as shown.

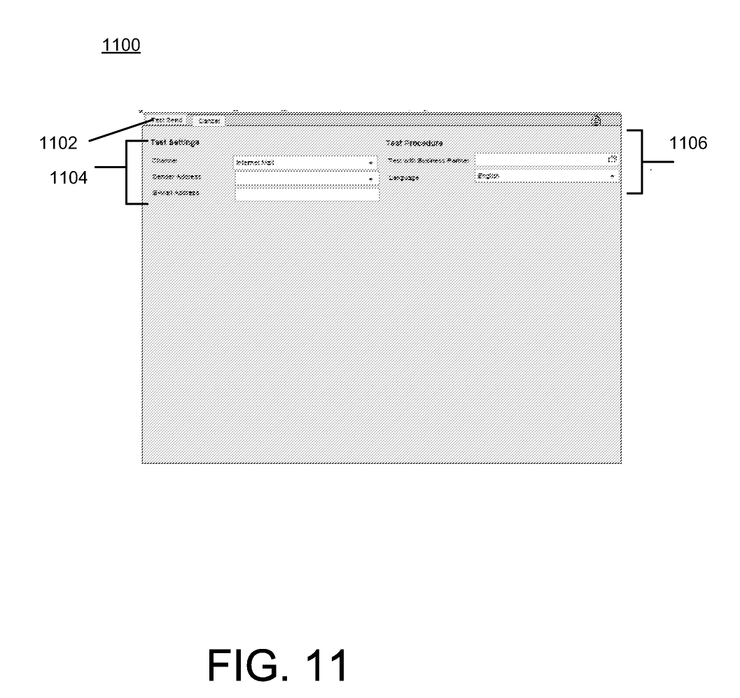

Additionally, an example Edit Structure feature 740 as shown in FIG. 7 may maintain text elements and assign conditions. Further, a Test Send feature 742 may be used to perform a test by sending an email generated based on the template or mail form to an email address so that a user may obtain an impression of the result as it may be received by the target recipient. FIG. 11 is a screen shot illustrating a channel test view 1100 according to an example embodiment. According to the example as shown in FIG. 11, a user may select “Test send” 1102 to send a test message after providing information regarding a test channel, a sender address, and a test recipient email address in a “Test settings” area 1104, and information regarding a language for the test message, and an indication of testing with a business partner in a “Test Procedure” area 1106. The user may then view the test message while still interacting with the user interface 104.

According to an example embodiment, hyperlinks 722 to any uniform resource locator (URL) may be inserted in a template or mail form.

According to an example embodiment, a subscription link to a newsletter 728 may be inserted. According to an example embodiment, personalized mails may be sent to a target group including recipients that may be interested in the newsletter. The subscription link may include a URL to a Web shop that may be configured to receive logins from recipients, and to maintain user profiles of the recipients.

For example, Marcus Adams may use a template or mail form to generate a newsletter. He may thus select the Subscribe to Newsletter link 728 to include a link to a Web shop. As a result, customers may register themselves and maintain user profiles using their newsletter interests.

According to an example embodiment, a user may request URL categories 904 for selecting hyperlinks. According to an example embodiment, features such as a description 906 to be displayed in a message instead of a URL may be selected. According to an example embodiment, a user may determine whether recipients click the hyperlinks in personalized messages.

According to an example embodiment, a URL category 904 may be used for response tracking. For example, a user may generate reports on visits to categories of hyperlinks as well as to individual hyperlinks based on URL categories 904.

According to an example embodiment, using test settings 1104, the user may select from communication channels such as email, Short message service (SMS), or Fax for a test send. According to an example embodiment, the user may then specify any email address, or SMS or fax number for the recipient of the test personalized mail.

According to an example embodiment, the user may test the attributes and conditions that have been inserted in a template or mail form. A target recipient may be selected, and the template or mail form may then be processed according to the target recipient's attribute values. The user may thus check that the personalized communication item includes the desired information as indicated by the template or mail form.

According to an example embodiment, a More field 744 as shown in FIG. 7 may be selected for example features such as attaching files, for adding attachments, such as PDF or MS Word documents to the template, or a translate feature, for translating subject and text elements into additional languages.

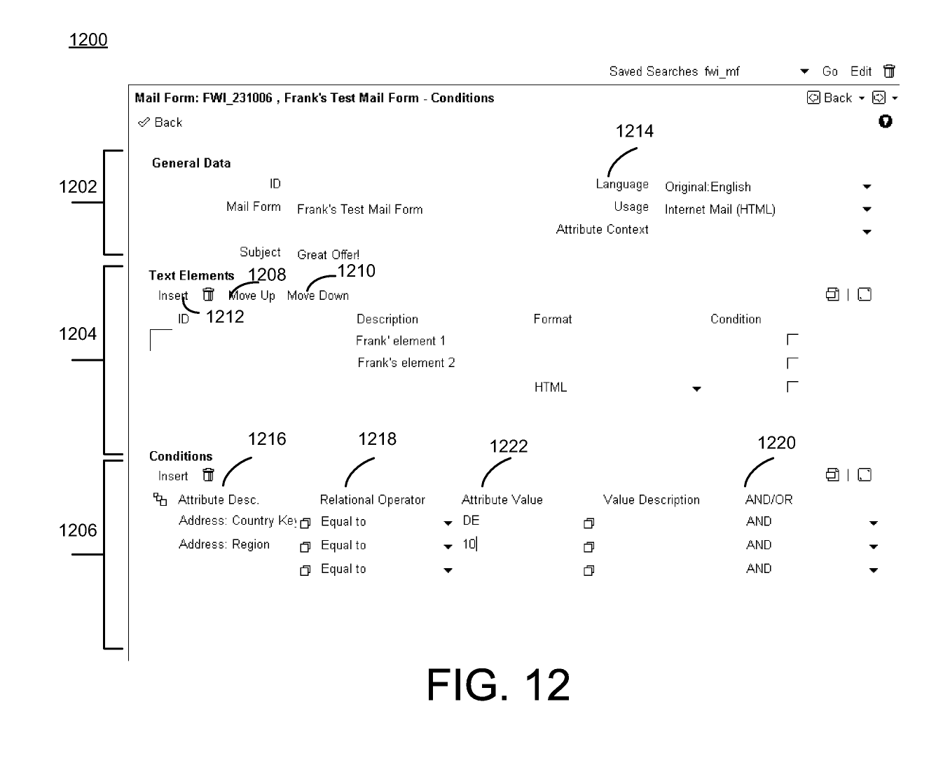

FIG. 12 is a screen shot illustrating a structure editing view 1200 according to an example embodiment. An upper portion 1202 of the example structure editing view 1200 illustrates information associated with the template or mail form, which may be revised.

A middle portion 1204 of the example structure editing view 1200 illustrates a list of all text elements that have been created for the template or mail form under consideration. According to an example embodiment, a user may modify their order as they occur in the communication item using buttons such as “Move up” 1208 and “Move Down” 1210. New text elements may be created 1212 or be deleted and descriptions may be modified according to a selected language 1214 in the general data view.

A lower portion 1206 of the example structure editing view 1200 may include conditions maintained for a text element that may be selected in the table above. These conditions may indicate whether the text element is to be included as part of a generated communication item at execution time. Example conditions may be used to control which text elements and attachments are sent to which recipients in a specified target group. Conditions may be based on attributes 1216.

According to an example embodiment, one or more conditions 1218 may be created for each text element or attachment, and conditions may be combined via logical operators 1220 such as logical AND or OR. According to an example embodiment, a condition may be created by selecting an attribute, an attribute value 1222, and a relational operator (e.g., equal to, not equal to, less than) 1218. When the personalized communication is sent, the determination of recipients of particular text elements and attachments may be based on attribute values of the recipients and the conditions included in the template or mail form.

For example, if a user plans a personalized-mail campaign in Spain, and additional plans a small promotional event in Madrid, the user may create a flyer for this event, and save it as an attachment in the template or mail form. The user may want to send personalized mail to all recipients in the target group, and may additionally wish to send the attachment to recipients in Madrid.

A condition may thus be generated for the attachment. For example, in the condition, an attribute 1216 “Address: City” may be selected. The user may then specify an attribute value 1222 of “Madrid,” and a relational operator 1218 “Equal to.” The attachment may then be sent to recipients who live in Madrid, but not to the other recipients who receive the personalized mail.

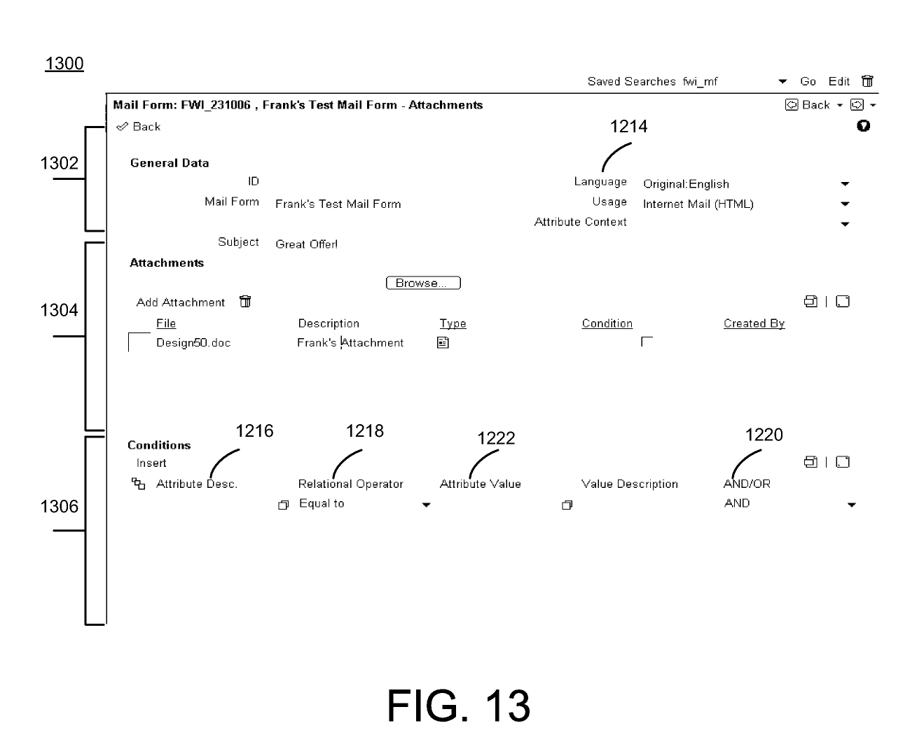

FIG. 13 is a screen shot illustrating an attachment assignment view 1300 according to an example embodiment. For the example of FIG. 13, the attachment assignment view 1300 is similar to the “Edit Structure” screen. According to an example embodiment, attachments with their related conditions may be assigned and maintained, respectively. An upper portion 1302 of the example structure editing view 1300 illustrates information associated with the template or mail form, which may be revised.

A middle portion 1304 of the example structure editing view 1300 illustrates an area for selecting attachments to be attached to communication items. New attachments may be added or attachments may be deleted from the template and descriptions may be modified according to a selected language in the general data view.

A lower portion 1306 of the example structure editing view 1300 may include conditions maintained for attachments. These conditions may indicate whether the attachment is to be included as part of a generated communication item at execution time. Example conditions may be used to control which attachments are sent to which recipients in a specified target group. Conditions may be based on attributes.

In the example as shown in FIG. 13, a user may preview an attachment by clicking a corresponding hyperlink.

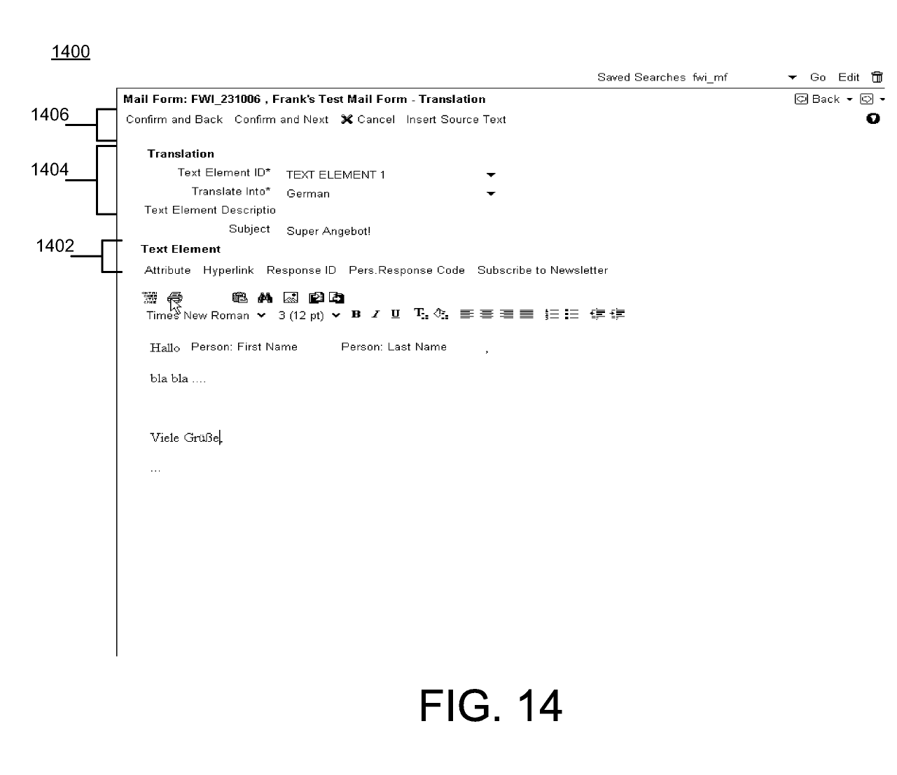

FIG. 14 is a screen shot illustrating a translation view 1400 according to an example embodiment. In the example as shown in FIG. 14, text elements 1402 may be translated 1404 into specified languages by selecting appropriate entries in dropdown listboxes.

According to an example embodiment, when a user “confirms” 1406 a translation, it may be temporarily saved and the next translation may be processed. After leaving the screen shown in FIG. 14 by selecting “Confirm and Back,” the translations may be persisted, for example, via the interaction controller layer 304 and persistency controller 308 discussed previously. According to an example embodiment, when a user selects “Insert Source Text,” the original text to be translated may be inserted into the editor and may serve as a template.

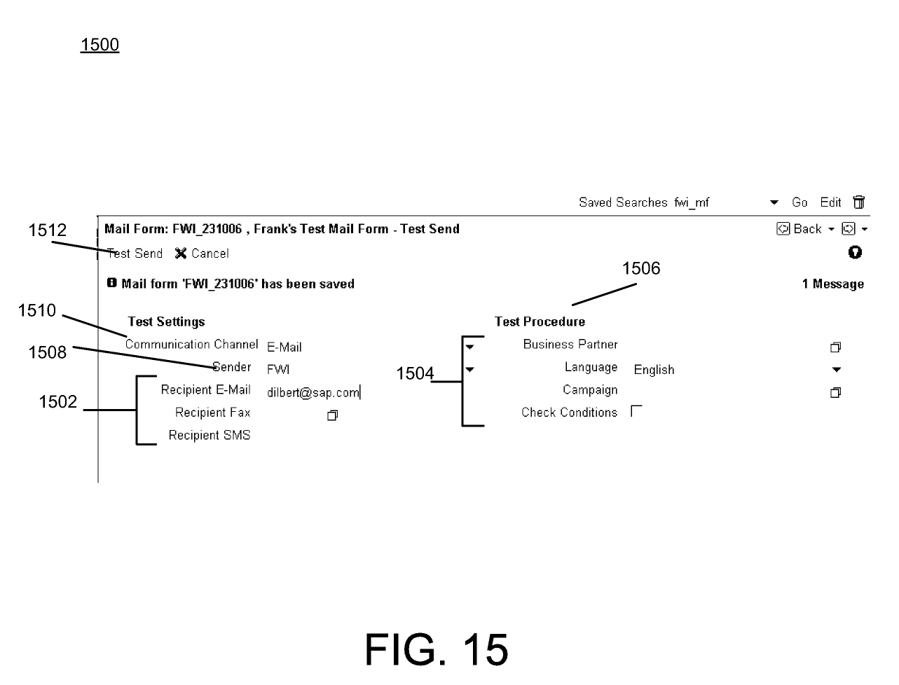

FIG. 15 is a screen shot illustrating a test send view 1500 according to an example embodiment. In the example as shown in FIG. 15, a mail form may be tested, as discussed previously. According to an example embodiment, a user may specify a recipient 1502 to receive a mail, fax or SMS message that is personalized according to settings 1504 under “Test Procedure” 1506. As shown in the example of FIG. 15, a sender 1508 identified as “FWI” may send a test message via a communication channel 1510 selected as “email” for the example, by selecting “Test send” 1512.

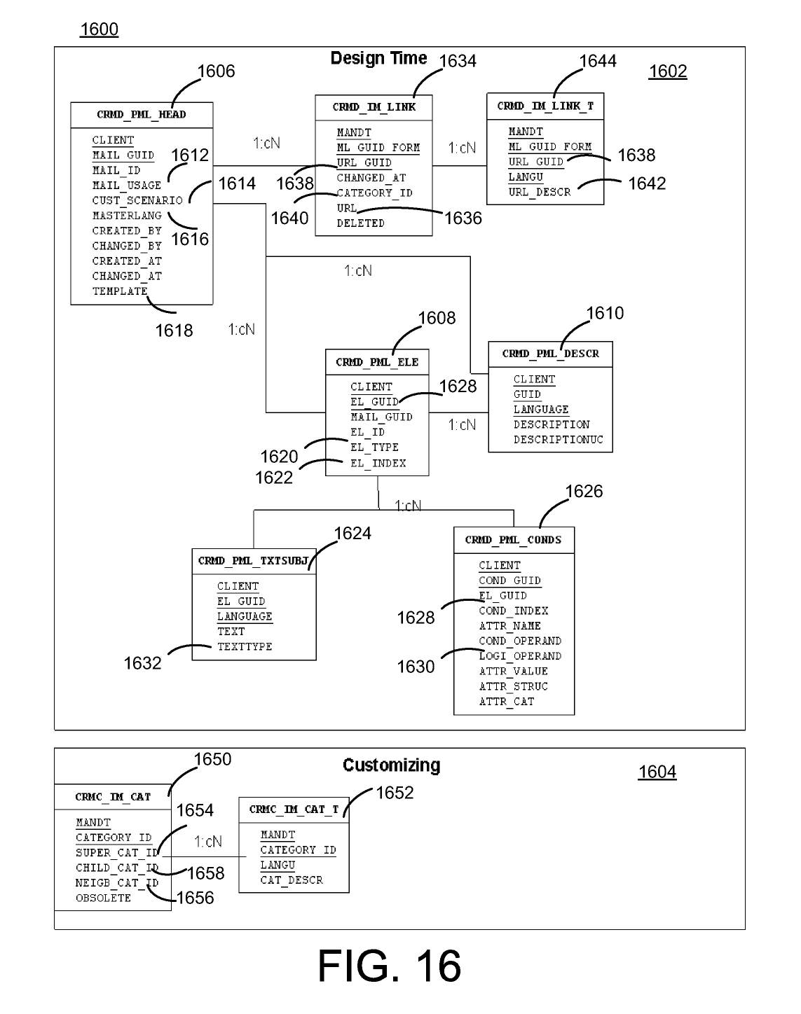

FIG. 16 illustrates a database design 1600 according to an example embodiment. The database design 1600 may include a Design Time area 1602 and a Customizing area 1604. For example, during a design time, or a maintenance time of mail forms or templates, tables included in the Design Time area 1602 of FIG. 16 may be filled in accordance with insertions by a user of a maintenance user interface.

A CRMD_PML_HEAD table 1606 may be configured to store administrative data associated with templates or mail forms, and a CRMD_PML_ELE table 1608 may be configured to store administrative data of the template or mail form elements. The CRMD_PML_ELE table1608 may be filled if a template or mail form element (e.g., =Subject, Text (=HTML body) or Attachment), a picture or a tracking enabled URL are inserted in a template or mail form or a condition is defined for a specific template or mail form element. Descriptions/short texts for templates or mail forms and their elements may be stored in a CRMD_PML_DESCR table 1610.

The CRMD_PML_HEAD table 1606 may include the administrative data associated with templates or mail forms, for example, a MAIL_USAGE field 1612 may include a combination of channel and text type, for example, “Email channel with HTML text”/“Fax channel with HTML”/“SMS channel with Plain Text.” These values may include default values for the actual email which may be generated based on a mail form or template. These default values may be overwritten during execution.

For example, a field CUST_SCENARIO 1614 may include an ID for personalization of a set of available attributes that may be included in the mail form. An example MASTERLANG field 1616 may include an original language in which a template or mail form was created. An example TEMPLATE field 1618 may indicate whether a template or mail form may be used to generate a new template or mail form via a “copy” operation.

The CRMD_PML_ELE table 1608 may include administrative data for the template or mail form elements. For example, an EL_TYPE field 1620 may indicate whether the element is a subject, a text element, or an attachment. For example, an EL_INDEX field 1622 may indicate a position/order of this element within a template or mail form. Element detail tables may also be filled, for example by a user 106 via the user interface 104. For example, a CRMD_PML_TXTSUBJ table 1624 may be filled for texts and for subject information. If an element should only be included in the template or mail form under several conditions (e.g., if, and only if “business partner ‘hobby’ is soccer”), the condition(s) may be included in a CRMD_PML_CONDS table 1626 and may be linked to a specific element in the CRMD_PML_ELE table 1608 via an EL_GUID field 1628. An example LOGI_OPERAND field 1630 indicating a logical operation such as “AND” or “OR” may indicate one or more element conditions that may be linked together.

According to an example embodiment, texts and subjects may be included in the CRMD_PML_TXTSUBJ table 1608 associated with an example TEXTTYPE 1632 (e.g., HTML, XML).

According to an example embodiment, a CRMD_IM_LINK table 1634 may include a URL field 1636. For example, URLs may be inserted in a text body (e.g., for linking with other web sides). For example, URLs with tracking capability (e.g., tracking enabled URL's may be identified via an attached suffix “##” or “++” at the end of the URL in the source code of an editor) may be stored in the CRMD_IM_LINK table 1634. For example, a URL_GUID field 1638 may combine the URL 1634 with attributes CATEGORY_ID 1640 (e.g., a category associated with the URL 1634) and a URL_DESCR 1642, which may include a description of the URL 1636, and may be stored in a CRMD_IM_LINK_T table 1644.

For example, the CRMD_IM_LINK table 1634 and CRMD_IM_LINK_T table 1644 may serve as extensions to the CRMD_PML_HEAD table 1606.

With regard to the Customizing area 1604 of FIG. 16, a CRMC_IM_CAT table 1650 and a CRMC_IM_CAT_T table 1652 may be filled for including categories in a template or mail form. For example, fields SUPER_CAT_ID 1654/NEIGB_CAT_ID 1656 and CHILD_CAT_ID 1658 may be included, but may not be filled within a customizing view. These fields may describe a hierarchical structure of categories, which may be assigned to the URLs in template or mail form maintenance.

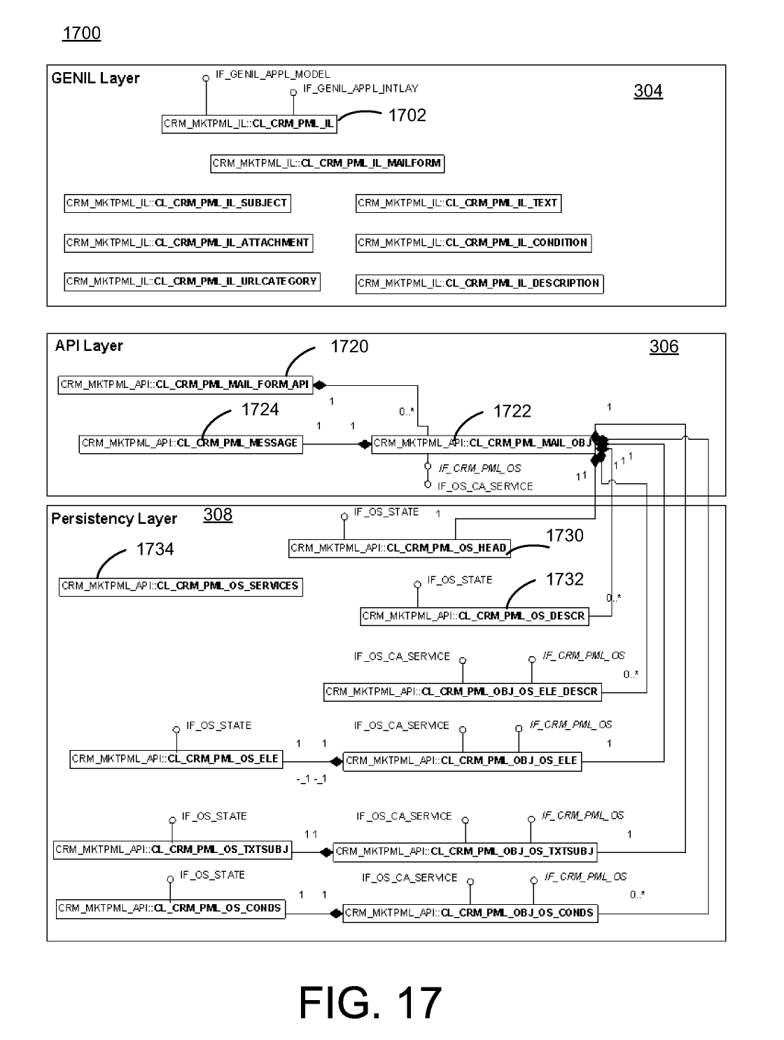

FIG. 17 illustrates classes associated with the system of FIG. 3 according to an example embodiment. According to an example embodiment, a GENIL layer 304, which may correspond to the interaction controller layer 304 discussed previously, may include interfaces, an API layer 306, which may correspond to the business logic controller layer 306, may include business logic associated with an object such as a template object or mailform object, and a Persistency layer 308, which may correspond to the Persistency Controller 308, may manage read, modify and save access to the DB 302 (e.g., access to single DB tables associated with the DB 302).

According to an example embodiment, the API layer 306 may include classes CL_CRM_PML_MAIL_FORM_API 1720 and CL_CRM_PML_MAIL_OBJ 1722. The class CL_CRM_PML_MAIL_FORM_API 1720 may include, for example, static methods to search for, access and manipulate particular instances of a business object, and may serve as a buffer at a business object level (e.g., buffering of elementary data at the DB level may be handled by classes of the persistency layer 308).

According to an example embodiment, the class CL_CRM_PML_MAIL_OBJ 1722 may represent a single instance of a business object associated with a template or mail form, and its attributes may be read and manipulated via calls of class CL_CRM_PML_MAIL_FORM_API 1720. According to an example embodiment, the class CL_CRM_PML_MAIL_OBJ 1722 may interact directly with the classes of the persistency layer 308 and may ensure consistency of the business data of the business object which may not be achievable on the persistency layer 308. According to an example embodiment, an example message handler class CL_CRM_PML_MESSAGE 1724 may create, buffer and retrieve messages.

According to an example embodiment, only administrative processing that is related to the persistency of various parts of a business object such as a template or mail form may be performed at the persistency layer 308. According to an example embodiment, no business logic across different DB tables may be included in the persistency layer 308. For each DB table, classes generated by the objects services may be included in the persistency layer 308: (a) an example agent class that provides access to instances of (b) persistency classes with GET and SET methods for each attribute of the DB table. These two types of classes may handle all access to the DB layer 302.

According to an example embodiment, administrative data associated with a template or mail form may be maintained in a DB table CRMD_PML_HEAD (not shown) in the DB layer 302. A reference to an instance of the persistency class CL_CRM_PML_OS_HEAD 1730 may be maintained as a private attribute of the CL_CRM_PML_MAIL_OBJ 1722. Language-dependent descriptions (e.g., in an example DB table CRMD_PML_DESCR) may be accessed via a persistency class CL_CRM_PML_OS_DESCR 1732, via a reference attribute of the CL_CRM_PML_MAIL_OBJ 1722.

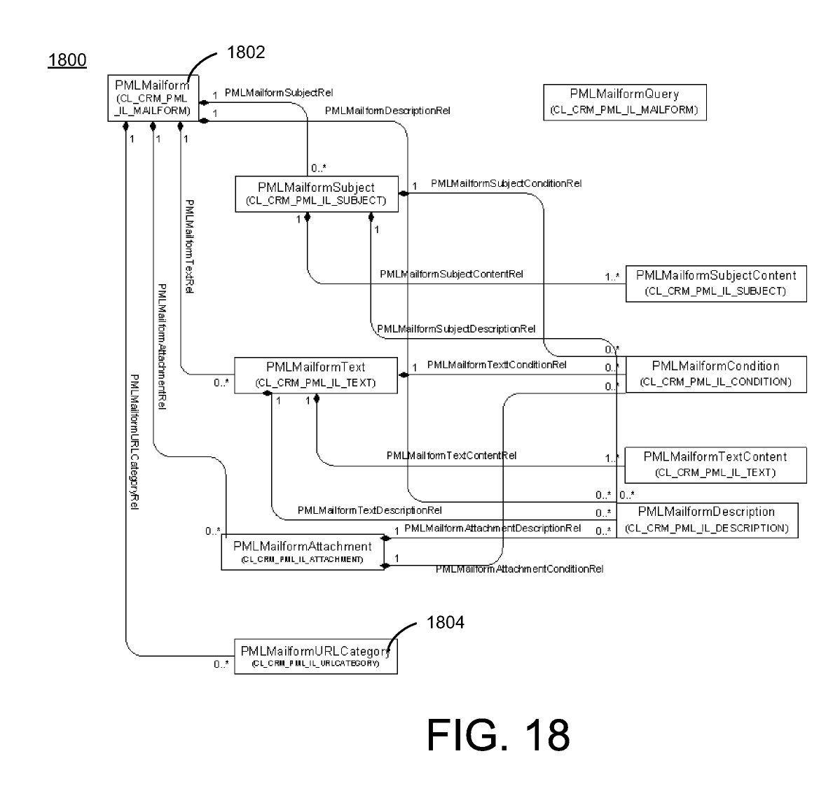

FIG. 18 illustrates an architectural view 1800 of a layer associated with the system of FIG. 3 according to an example embodiment. The example of FIG. 18 illustrates an overview of an example architecture and example implementation classes associated with the GENIL layer 304 discussed previously. For example entities shown in FIG. 18, responsible handler classes associated with READ, MODIFY, etc. may be indicated within parentheses.

A root object PMLMailform 1802 may handle administrative data of a template or mail form. Example dependent objects for each type of template or mail form element (e.g., subjects, text objects, attachments) are also shown in FIG. 18. Subject and text objects may each include children that may be responsible for (a) the content and (b) the assigned conditions that may indicate when to include the element in a communication item and (c) the description. An example dependent object for attachments may include no further ‘content’ children since it may include access to that information that is needed to retrieve the corresponding documents.

Additionally, an example PMLMailformURLCategory 1804 may be assigned to the root object PMLMailform 1802 to provide access to URL category information.

According to an example embodiment, for each entity there may be included a corresponding GENIL handler class, for handling at least READ and MODIFY methods. Further methods may be included.

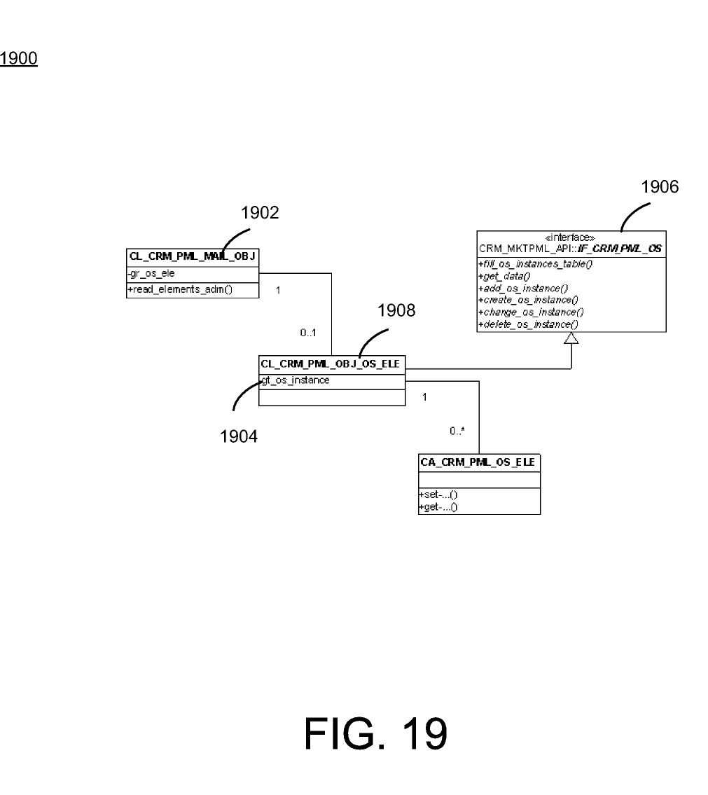

FIG. 19 illustrates an architectural view 1900 of a layer associated with the system of FIG. 3 according to an example embodiment. According to an example embodiment, with regard to the elements of a mail form, such as texts or subjects, a reference attribute of the class CL_CRM_PML_MAIL_OBJ 1902, analogous to CL_CRM_PML_MAIL_OBJ 1722, referencing an instance of the persistency class may not be feasible, since there exists a 1:n relationship. Therefore, for the administrative data of elements and each element type, classes may (a) include an internal table of instances of corresponding persistency classes GT_OS_INSTANCE 1904, and (b) implement an interface IF_CRM_PML_OS 1906 to access the data of these instances. According to an example embodiment, for each persistency element, functionality for accessing the DB layer 302 may be encapsulated in a class, e.g., CL_CRM_PML_OS_ELE 1908, for the administrative data of template or mail form elements with a coherent interface for accessing the data.

According to an example embodiment, a class CL_CRM_PML_OS_SERVICES 1734 may provide generic methods for SET and GET as well as search functionality on a structure level, as the generated persistency classes may only offer separate SET and GET methods for each attribute of the DB table. An addition of a new attribute may thus require the adaptation of multiple code parts. The methods of the class CL_CRM_PML_OS_SERVICES 1734 may receive or return whole structures filled with all DB attributes instead of single attributes, as may occur with the persistency classes.

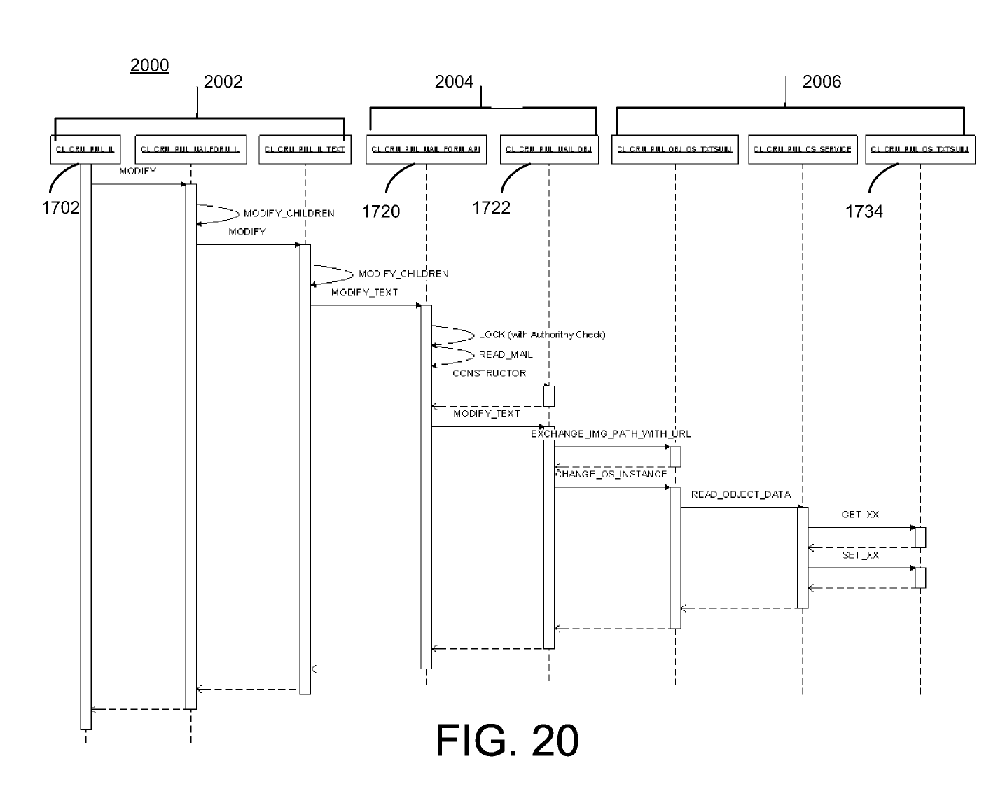

FIG. 20 is a timing diagram 2000 illustrating edit of a test message according to an example embodiment. The example of FIG. 20 illustrates an example operation “MODIFY TEXT” processed through multiple layers, starting at the GENIL layer 304 at 2002, processing through the API layer 306 at 2004, and through the generated persistency class at the persistency layer 308, at 2006.

According to an example embodiment, personalized communication items may also be executed by external agencies, for example, as a part of direct marketing activity during which a certain target group is to be personally contacted via mail, fax, SMS or email. For example, the external agencies may receive data files with the extracted customer data and may send out personalized communication items based on this data. As another example, the external agencies may contact members of the target group via calls or personal visits based on the extracted data.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A system comprising:
a personalized communication manager including:
a template information manager configured to obtain template information associated with a personalized communication item via one or more application programming interfaces, and
a hierarchical template manager configured to generate a hierarchical template including a description of an execution service associated with the personalized communication item based on the template information, wherein the execution service is configured to provide the personalized communication item to a target recipient based on the hierarchical template.

2. The system of claim 1 wherein the personalized communication manager further comprises:
a template update manager configured to update the hierarchical template via a user interface.

3. The system of claim 1 wherein the hierarchical template manager is configured to generate the hierarchical template according to a hierarchical ordering based on one or more of:
one or more attribute structures associated with the personalized communication item,
one or more methods associated with the personalized communication item, or
one or more relations associated with the personalized communication item.

4. The system of claim 1 wherein:
the template information manager is configured to update the template information via a user interface.

5. The system of claim 1 wherein the personalized communication manager further comprises:
a communication test manager configured to generate test personalized communication items based on the hierarchical template for review by a user of the system.

6. The system of claim 1 wherein the personalized communication manager further comprises:
a template information database configured to store the template information;
a hierarchical template database configured to store the hierarchical template; and
a template update manager configured to update the hierarchical template based on user input, and store the updated hierarchical template in the hierarchical template database, wherein
the template information manager is configured to update the template information based on user input, and store the updated template information in the template information database.

7. The system of claim 1 wherein:
the hierarchical template includes one or more of:
one or more variables indicating one or more attributes associated with the target recipient;
one or more condition indicators indicating conditions for including predetermined content in the personalized communication item;
one or more indicators of data values, attachments, hyperlink tracking, response tracking, personalized subject lines, or subscriptions to newsletters for inclusion in the personalized communication item.

8. The system of claim 1 wherein:
the personalized communication item includes one or more of an email message, a facsimile message, a letter, a personalized web page, or an electronic text message.

9. The system of claim 1 wherein:
the personalized communication item includes a business message personalized based on personal information associated with a client associated with a business entity.

10. The system of claim 1 wherein:
the execution service is configured to generate the personalized communication item based on the template information.

11. The system of claim 1 wherein:
the personalized communication item includes one or more of a uniform resource locator (URL), an indicator of a channel associated with a communication transmission, or a language indicator associated with the personalized communication item.

12. The system of claim 11 wherein:
the URL includes a tracking URL;
the indicator of the channel indicates one or more of email, facsimile, letter, personalized web page, Short Message Service (SMS), file export, or electronic text message; and
the language indicator indicates a language understood by one or more of the target recipient or a user of the system.

13. A system comprising:
a database layer configured to store template information associated with a personalized communication item and a template including a description of an execution service associated with the personalized communication item based on the template information, wherein the execution service is configured to provide the personalized communication item to a target recipient based on the hierarchical template;
an interaction controller including one or more application programming interfaces and a user interface configured to receive user input associated with the template and template information;
a business logic controller configured to obtain the template information via the interaction controller; and
a persistency controller configured to store and retrieve information associated with the database layer.

14. The system of claim 13 wherein:
the interaction controller is configured to receive requests for updating the template and template information.

15. The system of claim 13 wherein:
the interaction controller is configured to receive requests for one or more of creating, reading, updating, or deleting information elements associated with the template.

16. The system of claim 13 wherein:
the persistency controller is configured to store and retrieve information associated with the database layer in binary format.

17. A method comprising:
obtaining template information associated with a personalized communication item via one or more application programming interfaces; and
generating a hierarchical template including a description of an execution service associated with the personalized communication item based on the template information, wherein the execution service is configured to provide the personalized communication item to a target recipient based on the hierarchical template.

18. The method of claim 17 and further comprising:
updating the hierarchical template via a user interface.

19. The method of claim 17 wherein:
generating the hierarchical template includes generating the hierarchical template according to a hierarchical ordering based on one or more of:
one or more attribute structures associated with the personalized communication item,
one or more methods associated with the personalized communication item, or
one or more relations associated with the personalized communication item.

20. The method of claim 17 and further comprising:
updating the template information via a user interface.

21. The method of claim 17 and further comprising:
storing the template information in a template information database;
storing the hierarchical template in a hierarchical template database;
updating the template information based on user input, the updated template information stored in the template information database; and
updating the hierarchical template based on user input, the updated hierarchical template stored in the hierarchical template database.

22. The method of claim 17 wherein:
the hierarchical template includes one or more of:
one or more variables indicating one or more attributes associated with the target recipient;
one or more condition indicators indicating conditions for including predetermined content in the personalized communication item;
one or more indicators of data values, attachments, hyperlink tracking, response tracking, personalized subject lines, or subscriptions to newsletters for inclusion in the personalized communication item.

23. The method of claim 17 wherein:
the personalized communication item includes one or more of an email message, a facsimile message, a letter, a personalized web page, a Short Message Service (SMS) message, a message included in a file export, or an electronic text message.
